(19) United States
(12) Patent Application Publication
(10) Pub. No.: US 2008/0210196 A1
(43) Pub. Date: Sep. 4, 2008

(54) Direct-Injection Internal Combustion Engine and Method of Controlling the Same

(75) Inventors: Takeshi Ashizawa, Kanagawa-ken (JP); Hiroshi Nomura, Shizuoka-ken (JP); Osamu Tomino, Shizuoka-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toyota Jidosha Kabushiki Kaisha, Toyota-shi, Aichi-ken (JP)

(21) Appl. No.: 11/916,900

(22) PCT Filed: Sep. 20, 2006
(86) PCT No.: PCT/IB06/02613

§ 371 Date: Dec. 7, 2007

(30) Foreign Application Priority Data
Sep. 21, 2005 (JP) 2005-274165

(51) Int. Cl. F02D 41/04; F01L 1/34

(52) U.S. Cl. 123/305; 123/90.15; 123/435

(57) ABSTRACT

In a direct-injection internal combustion engine, a variable intake valve, of which valve timing can be varied, is used as an air intake valve through which an air intake path and a combustion chamber communicate with each other. The direct-injection internal combustion engine includes: a variable-intake-valve control section that controls the valve timing of the variable intake valve; and an intake-air temperature acquisition section that acquires a temperature of the intake air introduced into the combustion chamber. When the fuel is injected into the combustion chamber via a fuel injection valve during a compression stroke or an expansion stroke, if the acquired intake-air temperature is low, the closing timing of the variable intake valve is advanced, so that the actual compression ratio is increased.

### BACKGROUND OF THE INVENTION

1. Field of the Invention

The present invention relates to a direct-injection internal combustion engine and a method of controlling the direct-injection internal combustion engine. More specifically, the present invention relates to a direct-injection internal combustion engine and a method of controlling the direct-injection internal combustion engine that inject the fuel via a fuel injection valve during a compression stroke or an expansion stroke.

2. Description of the Related Art

In recent years, direct-injection internal combustion engines are currently available, in which fuel is directly injected into the combustion chambers via fuel injection valves. In the direct-injection internal combustion engine, the combustion mode changes from a stratified-charge combustion to a homogeneous-charge combustion, according to the state in which the internal combustion engine is operating. The stratified-charge combustion is performed mainly during light load and low speed operation, such as when the engine is just started. When the stratified-charge combustion is performed, fuel is injected into the combustion chamber via the fuel injection valve during at least one of the compression stroke and the expansion stroke.

As a type of direct-injection internal combustion engines, wall-guided direct-injection internal combustion engines are available. In a wall-guided direct-injection internal combustion engine, fuel injected while the stratified-charge combustion is performed goes toward an ignition plug, running along a wall surface of the cylinder or the piston crown portion. When going toward the ignition plug, the fuel mixes with the intake air already introduced from the air intake path into the combustion chamber. The air-fuel mixture is ignited by the ignition of the ignition plug, which results in the combustion of the fuel in the mixture.

As disclosed in Japanese Patent Application Publication No. JP-A-2002-138933, spray-guided direct-injection internal combustion engines are available. In a spray-guided direct-injection internal combustion engine, fuel injected during the stratified-charge combustion is mixed with the intake air introduced from the air intake path into the combustion chamber to form a mixture near the ignition plug. Thereafter, the mixture is ignited by the ignition or the ignition plug, which results in the combustion of the fuel in the mixture. In the case of the spray-guided direct-injection internal combustion engine, the fuel injected into the combustion chamber via the fuel injection valve is neither directed to the ignition plug by causing the fuel to run along the wall surface of the cylinder or the piston crown portion, nor directed to the ignition plug by the flow of the intake air in the combustion chamber.

With regard to the direct-injection internal combustion engine, the time that can be used to vaporize the fuel injected via fuel injection valves during the stratified-charge combustion is short as compared to the homogeneous-charge combustion in which the fuel is injected into combustion chambers via the fuel injection valves during an intake stroke. This is because, when the stratified-charge combustion is performed, the fuel is injected into the combustion chambers via the fuel injection valves during a compression stroke or an expansion stroke, and, therefore, the period of time from when the fuel is injected to when the mixture is ignited by the ignition of the ignition plugs is short. Accordingly, with regard to the direct-injection internal combustion engines, there has been a problem that, during the stratified-charge combustion, when the temperature in the combustion chambers, that is, the in-cylinder temperature, is low because the temperature of the intake air introduced from the intake paths into the combustion chambers is low, combustion can be degraded.

In particular, in a spray-guided direct-injection internal combustion engine, unlike the wall-guided direct-injection internal combustion engine, the injected fuel is not directed to the ignition plug by causing the fuel to run along the wall surface of the cylinder or the piston crown portion. For this reason, it is difficult for the heat sources, such as the cylinder block and the piston, to help vaporize the fuel. Accordingly, with regard to the spray-guided direct-injection internal combustion engines, there has been a problem that, when the in-cylinder temperature is low because the intake-air temperature is low, combustion can be further degraded.

### SUMMARY OF THE INVENTION

The present invention provides a direct-injection internal combustion engine and a method of controlling the direct-injection internal combustion engine that inhibit the degradation of combustion during the stratified-charge combustion.

A first aspect of the present invention is a direct-injection internal combustion engine, in which fuel injected into a combustion chamber via a fuel injection valve during a compression stroke or an expansion stroke is mixed with intake air introduced into the combustion chamber through an air intake path to form an air-fuel mixture near an ignition plug, the engine including: actual-compression-ratio control means for controlling actual compression ratio; and representative-value acquisition means for acquiring a value representing an in-cylinder temperature, wherein, when the fuel is injected into the combustion chamber via the fuel injection valve during the compression stroke or the expansion stroke, if the acquired representative value is low, the actual-compression-ratio control means increases the actual compression ratio.

A second aspect of the present invention is a direct-injection internal combustion engine according to the first aspect, wherein a variable intake valve, of which valve timing can be varied, is used as an air intake valve through which the air intake path and the combustion chamber communicate with each other, the actual-compression-ratio control means is variable-intake-valve control means for controlling the valve tinting of the variable intake valve, and the variable-intake-valve control means advances the closing timing of the variable intake valve when the fuel is injected into the combustion chamber via the fuel injection valve during the compression stroke or the expansion stroke.

A third aspect of the present invention is a direct-injection internal combustion engine according to the second aspect, wherein the variable-intake-valve control means increases an advance amount of the closing timing of the variable intake valve in proportion to the decrease in the acquired representative value.

According to these aspects of the present invention, when the fuel is injected via the fuel injection valve during the compression stroke or the expansion stroke, the actual-compression-ratio control means, the variable-intake-valve control means for example, advances the closing timing of the variable intake valve when the acquired representative value representing the in-cylinder temperature, such as an intake-air temperature and a coolant temperature, is low. In this way, the closing timing of the variable intake valve is brought close to the time point at which the piston is at the bottom dead center, the amount of air to be introduced into the combustion chambers is increased, and the actual compression ratio is increased. For example, the actual compression ratio is increased by increasing the advance amount of the closing timing of the variable intake valves in proportion to the decrease in the acquired representative value, that is, the in-cylinder temperature. Accordingly, during the stratified-charge combustion, even if the fuel in the combustion chambers is difficult to vaporize, the actual compression ratio is increased, which causes the in-cylinder temperature to increase. In this way, the vaporization of the fuel is accelerated.

A fourth aspect of the present invention is a direct-injection internal combustion engine, in which fuel injected into a combustion chamber via a fuel injection valve during a compression stroke or an expansion stroke is mixed with intake air introduced into the combustion chamber through an air intake path to form an air-fuel mixture near an ignition plug, the engine including: fuel-pressure control means for controlling pressure of the fuel to be injected into the combustion chamber via the fuel injection valve; and representative-value acquisition means for acquiring a value representing an in-cylinder temperature, wherein, when the fuel is injected into the combustion chamber via the fuel injection valve during the compression stroke or the expansion stroke, if the acquired representative value is low, the fuel-pressure control means increases the fuel pressure.

A fifth aspect of the present invention is a direct-injection internal combustion engine according to the fourth aspect, wherein the fuel-pressure control means increases an amount of increase in the fuel pressure in proportion to the decrease in the acquired representative value.

According to these aspects of the present invention, when the fuel is injected via the fuel injection valve during the compression stroke or the expansion stroke, the fuel-pressure control means increases pressure of the fuel to be injected into the combustion chamber via the fuel injection valve when the acquired representative value representing the in-cylinder temperature, such as an intake-air temperature and a coolant temperature, is low. In this way, the atomization of the fuel that occurs when the fuel is injected into the combustion chambers is promoted. For example, the amount of increase in the fuel pressure is increased in proportion to the decrease in the acquired representative value, that is, the in-cylinder temperature. Thus, the atomization of the injected fuel is promoted. Accordingly, during the stratified-charge combustion, even if the fuel in the combustion chambers is difficult to vaporize, the atomization of the fuel is promoted, and it becomes easy for the fuel to vaporize. In this way, the vaporization of the fuel is accelerated.

A sixth aspect of the present invention is a direct-injection internal combustion engine according to any one of the first to fifth aspects, the engine including: at least one of intake-air temperature detecting means for detecting a temperature of the intake air introduced into the combustion chamber through the air intake path, and coolant temperature detecting means for detecting a temperature of coolant that circulates in the direct-injection internal combustion engine, wherein the representative value to be acquired by the representative-value acquisition means is at least one of the detected intake-air temperature and the detected coolant temperature.

According to the sixth aspect of the present invention, the representative-value acquisition means acquires, as the representative value, at least one of the intake-air temperature, which represents the in-cylinder temperature and has a direct influence thereon, and the coolant temperature, which represents the in-cylinder temperature and has an indirect influence thereon. Thus, the variation of the in-cylinder temperature is accurately acquired without any temperature sensors in the combustion chambers.

A seventh aspect of the present invention is a method of controlling a direct-injection internal combustion engine, in which fuel injected into a combustion chamber via a fuel injection valve during a compression stroke or an expansion stroke is mixed with intake air introduced into the combustion chamber to form an air-fuel mixture near an ignition plug, the method including the steps of: acquiring a value representing an in-cylinder temperature; and when the fuel is injected into the combustion chamber via the fuel injection valve during the compression stroke or the expansion stroke, if the acquired representative value is low, increasing actual compression ratio.

The direct-injection internal combustion engine and the method of controlling the direct-injection internal combustion engine according to these aspects of the present invention can inhibit the degradation of combustion by accelerating the vaporization of the fuel in the combustion chambers during the stratified-charge combustion.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a diagram showing a configuration example of a spray-guided direct-injection internal combustion engine of a first embodiment;

FIG. 2A is a diagram showing an arrangement of a fuel injection valve and an, ignition plug in relation to a combustion chamber;

FIG. 2B is a diagram showing a sectional view taken along the line 2B-2B of FIG. 2A;

FIG. 3 is a diagram showing an operational flow of the direct-injection internal combustion engine of the first embodiment;

FIG. 4 is a diagram showing a variable-intake-valve closing timing map;

FIG. 5 is a diagram showing a configuration example of a spray-guided direct-injection internal combustion engine of the second embodiment;

FIG. 6 is a diagram showing an operational flow of the direct-injection internal combustion engine of the second embodiment; and

FIG. 7 is a diagram showing a fuel pressure (P) map.

### DETAILED DESCRIPTION OF THE PREFERRED EMBODIMENTS

The present invention will be described below in detail with reference to the drawings. The present invention is not limited to embodiments described below. The embodiments include such elements that can be easily imagined by those skilled in the art, and/or ones that are substantially the same as such elements.

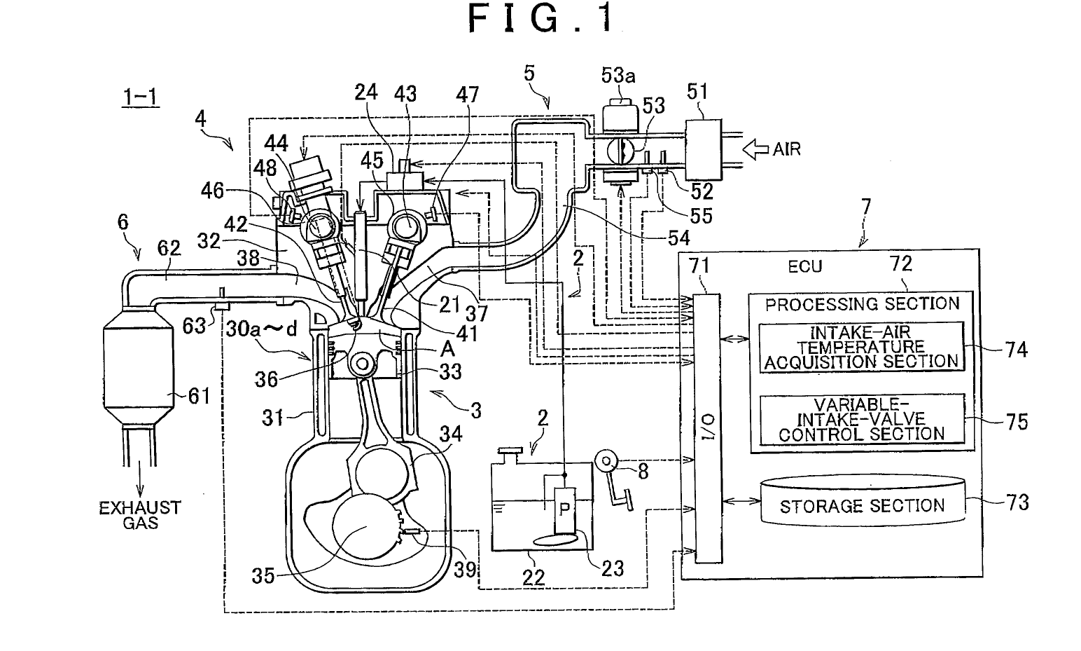

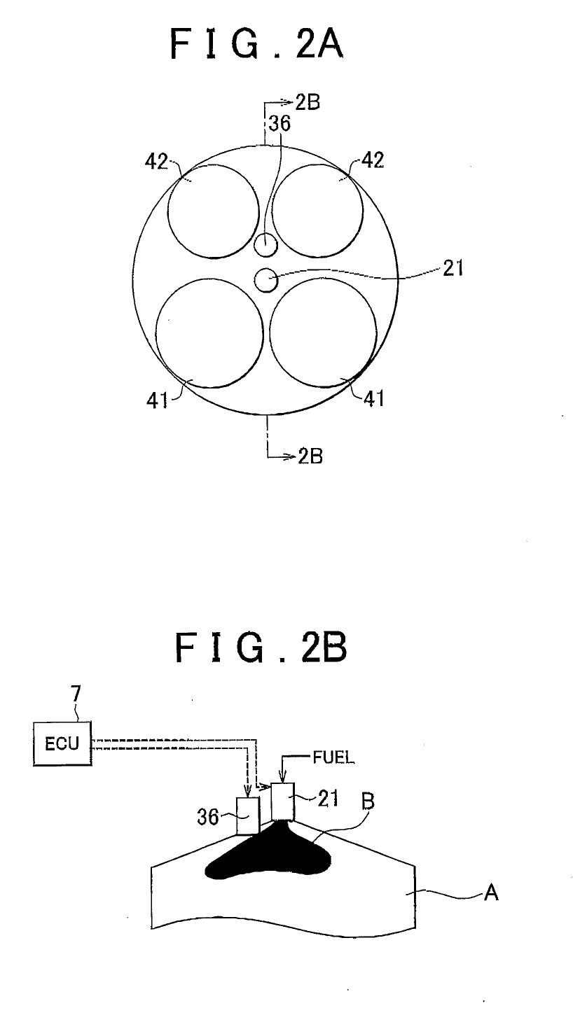

FIG. 1 is a diagram showing a configuration example of a spray-guided direct-injection internal combustion engine according to the first embodiment. FIG. 2A is a diagram showing an arrangement of the fuel injection valve and the ignition plug in relation to the combustion chamber. FIG. 2B shows a sectional view taken along the line 2B-2B of FIG. 2A. As shown in FIG. 1, the direct-injection internal combustion engine 1-1 includes: fuel supply equipment 2; an internal combustion engine body 3, constituted of a plurality of cylinders (in-line four cylinders, in the first embodiment); an air intake path 5 connected to the internal combustion engine body 3; an exhaust path 6, connected to the internal combustion engine body 3; and an ECU (Electronic Control Unit) 7, which is an operation controller that controls the operation of the direct-injection internal combustion engine 1-1.

The fuel supply equipment 2 is used to supply fuel, for example, gasoline, stored in a fuel tank 22, to the direct-injection internal combustion engine 1-1. The fuel supply equipment 2 includes: the fuel injection valves 21, the fuel tank 22, a low-pressure fuel pump 23; a high-pressure fuel pump 24; and fuel supply piping (not shown).

Each of the cylinders 30a to 30d of the internal combustion engine body 3 is provided with a fuel injection valve 21. The fuel injection valves 21 inject the fuel, which is pressurized by the low-pressure fuel pump 23 and the high-pressure fuel pump 24, into the respective combustion chambers A of the cylinders 30a to 30d. The fuel injection valve 21 is disposed near the ignition plug 36 (to be is described later) to make it possible to guide the spray, as shown in FIGS. 2A and 2B. The injection direction of the fuel of the fuel injection valve 21 is set so that, during the stratified-charge combustion, that is, when the fuel is injected into a combustion chamber A via the fuel injection valve 21 during at least one of the compression stroke and the expansion stroke, the fuel B injected into the combustion chamber A is mixed with the intake air already introduced from, the air intake path 5 to the combustion chamber A via a pair of variable intake valves 41 (to be described later) to form an air-fuel mixture near the ignition plug 36. The ECU 7 controls the fuel injection amount and the injection timing of the fuel injection valve 21, that is, performs the fuel injection control.

The high-pressure fuel pump 24 further increases the pressure of the fuel supplied from the fuel tank 22 of which pressure is increased by the low-pressure fuel pump 23. The rotation of a pump-driving cam (not shown) attached to an intake camshaft 43 of a variable valve system 4, for example, drives the high-pressure fuel pump 24. The intake camshaft 43 rotates with the rotation of a crankshaft 35. Accordingly, the high-pressure fuel pump 24 is driven by the output of the internal combustion engine 1-1.

The high-pressure fuel pump 24 is provided with a solenoid spill valve (not shown). The solenoid spill valve regulates the amount of fuel that flows into the high-pressure fuel pump 24, the pressure of which has been increased by the low-pressure fuel pump 23. The high-pressure fuel pump 24 regulates fuel pressure P, which is the pressure of the fuel to be discharged from the high-pressure fuel pump 24, that is, to be injected into the combustion chambers A via the fuel injection valves 21, by regulating the fuel inflow via the solenoid spill valve (not shown). The ECU 7 controls the amount of fuel that flows into the high-pressure fuel pump 24, that is, performs the inflow control, via the solenoid spill valve (not shown).

The internal combustion engine body 3 includes: a cylinder block 31; a cylinder head 32 fixed to the cylinder block 31; a piston 33 and a connecting rod 34 that are provided for each of the cylinders 30a to 30d; the crankshaft 35; an ignition plug 36, which is provided for each of the cylinders 30a to 30d; and the variable valve system 4. In each of the cylinders 30a to 301 of the internal combustion engine body 3, the combustion chamber A is formed by the piston 33 of each of the cylinders 30a to 30d, the cylinder block 31, and the cylinder head 32. In the cylinder head 32, an air inlet port 37 and an exhaust port 3S are formed for each of the cylinders 30a to 30d, and are connected to the air intake path 5 and the exhaust path 6, respectively. The piston 33 is freely rotatably coupled to the connecting rod 34. The connecting rod 34 is freely rotatably coupled to the crankshaft 35. Accordingly, when the air-fuel mixture is burned in the combustion chambers A, the pistons 33 reciprocate in the cylinder block 31, which causes the crankshaft 35 to rotate.

The ignition plug 36 is provided for each or the cylinders 30a to 30d. The ignition plugs 36 fire in accordance with the ignition signals from the ECU 7 to ignite the mixture in the combustion chambers A of the cylinders 30a to 30d. The ignition plug 36 is disposed near the fuel injection valve 21 as described above so as to make it possible to guide the spray, as shown in FIGS. 2A and 2B. The ECU 7 controls the ignition timing of the ignition plugs 36, that is, performs the ignition control.

A crank angle sensor 39 detects the crank angle (CA), the rotation angle or the crankshaft 35, and outputs the angle to the ECU 7. The ECU 7 determines the number of revolutions of the internal combustion engine 1-1, and identifies each of the cylinders 30a to 30d, based on the crank angle detected by the crank angle sensor 39.

The variable valve system 4 causes the variable intake valves 41 and variable exhaust valves 42 to open and close. The variable valve system 4 includes: a pair of the variable intake valves 41 and a pair of the variable exhaust valves 42 that are provided for each of the cylinders 30a to 30d; the intake camshaft 43; an exhaust camshaft 44; a variable-intake-valve timing mechanism 45; and a van able-exhaust-valve timing mechanism 46. The variable intake valves 41 are disposed between the air inlet ports 37 and the combustion chambers A, and are opened and closed due to the rotation of the intake camshaft 43. The variable exhaust valves 42 are disposed between the exhaust ports 38 and the combustion chambers A, and are opened and closed due to the rotation of the exhaust camshaft 44. The intake camshaft 43 and the exhaust camshaft 44 are coupled to the crankshaft 35 via a timing chain, and rotate with the rotation of the crankshaft 35.

The variable-intake-valve timing mechanism 45 is disposed between the intake camshaft 43 and the crankshaft 35. The variable-exhaust-valve timing mechanism 46 is disposed between the exhaust camshaft 44 and the crankshaft 35. The variable-intake-valve timing mechanism 45 and the variable-exhaust-valve timing mechanism 46 are continuously variable valve timing mechanisms, which continuously to vary the phases of the intake camshaft 43 and the exhaust camshaft 44, respectively.

An advance chamber and a retard chamber (not shown) are formed in the variable-intake-valve timing mechanism 45 and the variable-exhaust-valve timing mechanism 46, respectively. Oil is supplied from an oil control valve (not shown) of the variable valve system 4 to one of the advance chamber and the retard chamber. The phases of the intake camshaft 43 and the exhaust camshaft 44 are advanced when the oil is supplied to the advance chamber, or retarded when the oil is supplied to the retard chamber. The variable valve system 4 adjusts the valve timing of the variable intake valves 41 and the variable exhaust valves 42 by changing the phases of the intake camshaft 43 and the exhaust camshaft 44. Specifically, the variable valve system 4 advances or retards the valve timing of the variable intake valves 41 and the variable exhaust valves 42. More specifically, the variable valve system 4 controls the advance amount and the retard amount of the valve timing of the variable intake valves 41 and the variable exhaust valves 42.

Two oil control valves (not shown) each assigned to the variable-intake-valve timing mechanism 45 and the variable-exhaust-valve tinting mechanism 46 supply oil to one of the advance chamber and the retard chamber of each of the variable-intake-valve timing mechanism 45 and the variable-exhaust-valve timing mechanism 46 by shifting the position of a spool valve provided in the oil control valve. The control or the positions of the two spool valves, that is, the control of the valve timing of the variable intake valves 41 and the control of the valve timing of the variable exhaust valves 42, are performed by the ECU 7 described later. The variable valve system 4 is provided with an intake-cam position sensor 47 and an exhaust-cam position sensor 48. The intake-cam position sensor 47 and the exhaust-cam position sensor 48 detect the rotational positions of the intake camshaft 43 and the exhaust camshaft 44, respectively, and output the positions to the ECU 7. In the first embodiment, the variable valve system 4 adjusts the valve timing of both of the variable intake valves 41 and the variable exhaust valves 42 by using the variable-intake-valve timing mechanism 45 and the variable-exhaust-valve timing mechanism 46, respectively. However, other embodiments of the present invention can be adopted without being limited to the above embodiment. For example, the variable valve system 4 may be provided with the variable-intake-valve timing mechanism 45 only. In this case, the variable valve system 4 adjusts the valve timing of the variable intake valves 41 only.

The air intake path 5 is used to take in air from the outside, and introduce the air into the combustion chambers A of the cylinders 30a to 30d of the internal combustion engine body 3. The air intake path 5 includes an air cleaner 51, an air flow meter 52, a throttle valve 53, an air intake passage 54, which connects the air cleaner 51 to the air inlet port 37 of each of the cylinders 30a to 30d, and an intake-air temperature sensor 55. The air cleaner 51 removes (lust particles from air that is introduced into the combustion chamber A of each of the cylinders 30a to 30d through the air intake passage 54 and the air inlet port 37. The air flow meter 52 detects the amount of air introduced into each of the cylinders 30a to 30d, that is, the amount of intake air, and outputs the amount to the ECU 7. An actuator 53a, such as a stepping motor, drives the throttle valve 53. The throttle valve 53 regulates the amount of intake air to be introduced to the combustion chamber A of each of the cylinders 30a to 30d. The ECU 7 performs the throttle-valve opening degree control, that is, the control of the opening degree of the throttle valve 53, which is described later. The intake-air temperature sensor 55 is installed in the air intake passage 54 downstream of the air cleaner 51. The intake-air temperature sensor 55, which is installed in the air intake passage 54 downstream of the air cleaner 51, detects intake-air temperature T of the intake air, which is introduced from the air intake path 5 into the combustion chamber A via the air inlet ports 37, and outputs the temperature to the ECU 7.

The exhaust path 6 is constituted of an exhaust-gas purification device 61, a silencer (muffler) (not shown), and an exhaust passage 62, which connects the exhaust ports 38 of each of the cylinders 30a to 30d to the silencer (muffler) through the exhaust-gas purification device 61. The exhaust-gas purification device 61 removes harmful substances contained in the exhaust gas introduced via the exhaust passage 62. The exhaust gas purified by removing the harmful substances is discharged into the atmosphere via the silencer (muffler) (not shown). The exhaust passage 62 located upstream of the exhaust-gas purification device 61 is provided with an A/F sensor 63, which detects the air-fuel ratio of the exhaust gas to be discharged into the exhaust passage 62, and outputs the air-fuel ratio to the ECU 7. The air-fuel ratio of the exhaust gas may be, detected by an O₂ sensor, which detects the oxygen content of the exhaust gas to be discharged into the exhaust passage 62, instead of the A/F sensor 63.

The ECU 7 controls the operation of the direct-injection internal combustion engine 1-1. Various input signals are supplied, to the ECU 7, from the sensors, which are attached to various portions of a vehicle on which the direct-injection internal combustion engine 1-1 is mounted. Specifically, the various input signals are, for example, the signal of the crank angle detected by the crank angle sensor 39 with which the crankshaft 35 is provided, the signals of the rotational positions of the intake camshaft and the exhaust camshaft detected by the intake-cam position sensor 47 and the exhaust-cam position sensor 48, respectively, the signal of the amount of intake air detected by the air flowmeter 52, the signal of the intake-air temperature T detected by the intake-air temperature sensor 55, the signal of the accelerator-pedal operation amount detected by an accelerator-pedal sensor 8, and the signal of the air-fuel ratio detected by the A/F sensor 63.

The ECU 7 outputs various output signals, based on these input signals and various maps stored in a storage section 73. Specifically, the various output signals are, for example, an injection signal for performing the fuel injection control of the fuel injection valves 21, a high-pressure-fuel-pump control signal for performing the control of the amount of fuel that flows into the high-pressure fuel pump 24, an ignition signal for performing the ignition control of the ignition plugs 36, the signal of the advance/retard amount of the variable intake valves for performing the control of the variable intake valves 41, the signal of the advance/retard amount of the variable exhaust valves for performing the control of the variable exhaust valves 42, and a throttle-valve opening degree signal for performing the control of the opening degree of the throttle valves 53.

The ECU 7 includes: an input/output section (I/O) 71 that inputs and outputs the input signals and the output signals; a processing section 72; and the storage section 73 that stores various maps, such as a fuel injection amount map, a variable-intake-valve closing timing map that is made based on the closing timing or the variable intake valves 41, and the intake-air temperature T. The processing section 72 has at least an intake-air temperature acquisition section 74, which is a representative-value acquisition means, and a variable-intake-valve control section 75, which is an actual-compression-ratio control means, which is a variable-intake-valve control means in the first embodiment. The processing section 72 includes a memory and a CPU (Central Processing Unit). The processing section 72 may implement the operation control and the like of the direct-injection internal combustion engine 1-1 by loading a program, which is made based on the operation control of the direct-injection internal combustion engine 1-1, into the memory, and executing the program. The storage section 73 may be constituted of a nonvolatile memory, such as a flash memory, a read-only nonvolatile memory, such as a ROM (Read Only Memory), a readable/writable volatile memory, such as a RAM (Random Access Memory), or a combination of the memory types.

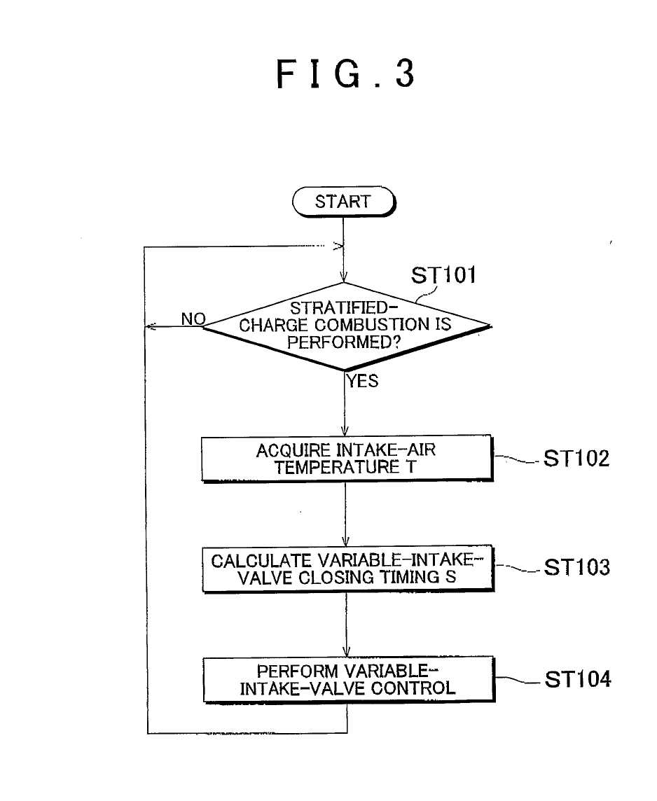

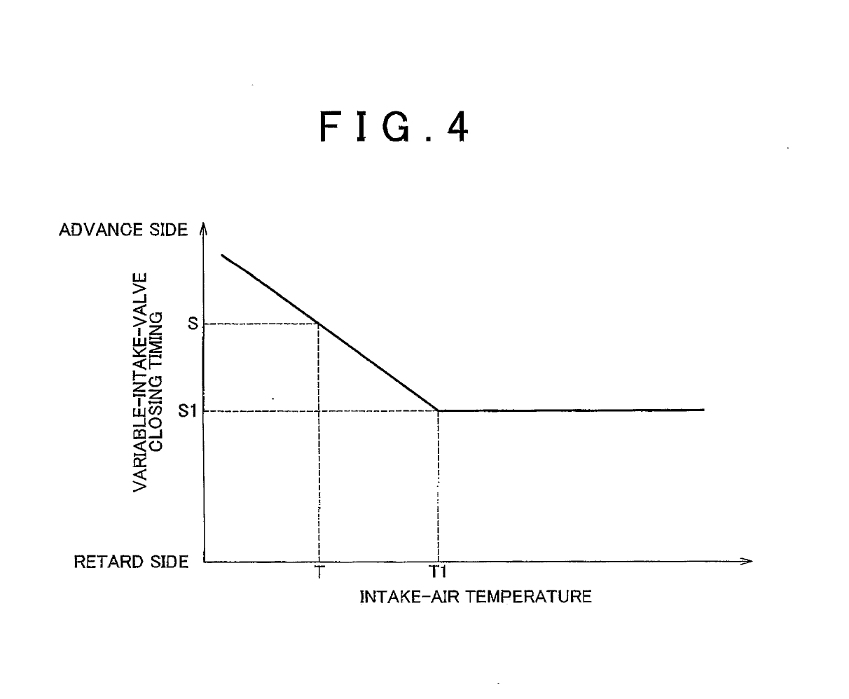

Next, the operation of the direct-injection internal combustion engine 1-1 of the first embodiment, in particular, an actual-compression-ratio control performed during the stratified-charge combustion, which is the variable-intake-valve control in the first embodiment, will be described. FIG. 3 shows the operational flow of the direct-injection internal combustion engine of the first embodiment. FIG. 4 is a diagram showing a variable-intake-valve closing timing map. As shown in FIG. 3, the processing section 72 of the ECU 7 determines whether the direct-injection internal combustion engine 1-1 is operating in a state where the stratified-charge combustion is occurring (ST101). Specifically, the processing section 72 determines whether fuel is being injected into the combustion chamber A of each or the cylinders 30a to 30d during at least one of a compression stroke and an expansion stroke of the cylinders 30a to 30d.

If the processing section 72 determines that the direct-injection internal combustion engine 1-1 is operating in a state where the stratified-charge combustion is occurring, the intake-air temperature acquisition section 74 acquires the intake-air temperature T detected by the intake-air temperature sensor 55 (ST102). The detected intake-air temperature T is the temperature of the intake air to be introduced from the air intake path 5 into the combustion chamber A. Accordingly, the intake-air temperature T has a direct influence on the in-cylinder temperature. Thus, the in-cylinder temperature varies approximately in proportion Lit the variation of the intake-air temperature T. For this reason, the variation of the in-cylinder temperature is accurately acquired without any temperature sensors in the combustion chambers A.

Subsequently, the variable-intake-valve control section 75 of the processing section 72 calculates variable-intake-valve closing timing S from the acquired intake-air temperature T, and the variable-intake-valve closing timing map that is made based on the variable-intake-valve closing timing S and the intake-air temperature T, which is stored in the storage section 73, and is shown in FIG. 4 (ST103). As shown in FIG. 4, the variable-intake-valve closing timing map is set so that, when the intake-air temperature T is lower than a predetermined intake-air temperature T1, the closing timing of the variable intake valve 41 is advanced relative to the desired closing timing S1, which is the closing timing of the variable intake valve 41 that depends on the state in which the direct-injection internal combustion engine 1-1 is operating. In particular, the variable-intake-valve closing timing map is set so that the advance amount of the closing timing of the variable intake valve 41 increases in proportion to the decrease in the intake-air temperature T when the intake-air temperature T is lower than the predetermined intake-air temperature T1. Accordingly, if the acquired intake-air temperature T is lower than the predetermined intake-air temperature T1, the calculated variable-intake-valve closing timing S is on the advance side of the desired closing timing S1. The predetermined intake-air temperature T1 means a temperature such that the intake-air temperature T lower than the predetermined intake-air temperature T1 may badly affect the combustion. For example, the predetermined intake-air temperature T1 is the intake-air temperature that occurs in a cold start state, more specifically, the intake-air temperature that occurs when the temperature of the purification catalyst of the exhaust-gas purification device and the in-cylinder temperature have dropped to sufficiently low temperature relative to the temperature that occurs when the direct-injection internal combustion engine 1-1 is operating because sufficient time has elapsed after the direct-injection internal combustion engine 1-1 is stopped.

Subsequently, the variable-intake-valve control section 75 of the processing section 72 performs variable-intake-valve control, which is the control of the valve timing of the variable intake valves 41, based on the calculated variable-intake-valve closing timing S (ST104). For example, the variable-intake-valve control section 75 supplies oil to the advance chamber of the variable-intake-valve timing mechanism 45, based on the advance amount that is the difference between the calculated variable-intake-valve closing timing S and the desired closing timing S1. In this way, the closing timing of the variable intake valves 41 is advanced. Specifically, when the direct-injection internal combustion engine 1-1 is operating in a state where the stratified-charge combustion is occurring, and the fuel is injected via the fuel injection valve 21 during the compression stroke or the expansion stroke, the variable-intake-valve control section 75 advances the closing timing of the variable intake valves 41 to bring the closing timing of the variable intake valve 41 close to the time point at which the piston 33 is at the bottom dead center. The variable-intake-valve control section 75 may determine, from the rotational position of the intake camshaft 43 detected by the intake-cam position sensor 47, whether the actual closing timing of the variable intake valves 41 is coinciding with the variable-intake-valve closing timing S, and may perform feedback control so that the actual closing timing of the variable intake valves 41 coincides with the calculated variable-intake-valve closing timing S. When it is determined that the acquired in-cylinder temperature T is equal to or higher than the predetermined in-cylinder temperature T1, the variable-intake-valve control section 75 performs the variable-intake-valve control so that the variable-intake-valve closing timing S coincides with the desired closing timing S1.

The variable-intake-valve control section 75 advances the closing timing of the variable intake valves 41, thereby making the closing timing of the variable intake valve 41 close to the time point at which the piston 33 is at the bottom dead center, increasing the amount of air to be introduced into the combustion chambers A, and increasing the actual compression ratio. In the first embodiment, the variable-intake-valve control section 75 increases the actual compression ratio by increasing the advance amount of the closing timing of the variable intake valves 41 in proportion to the decrease in the intake-air temperature r, which is the acquired representative value representing the in-cylinder temperature. Accordingly, during the stratified-charge combustion, even if the fuel in the combustion chambers A is difficult to vaporize, the vaporization of the fuel is accelerated by increasing the in-cylinder temperature by increasing the actual compression ratio. In this way, the degradation of combustion is inhibited.

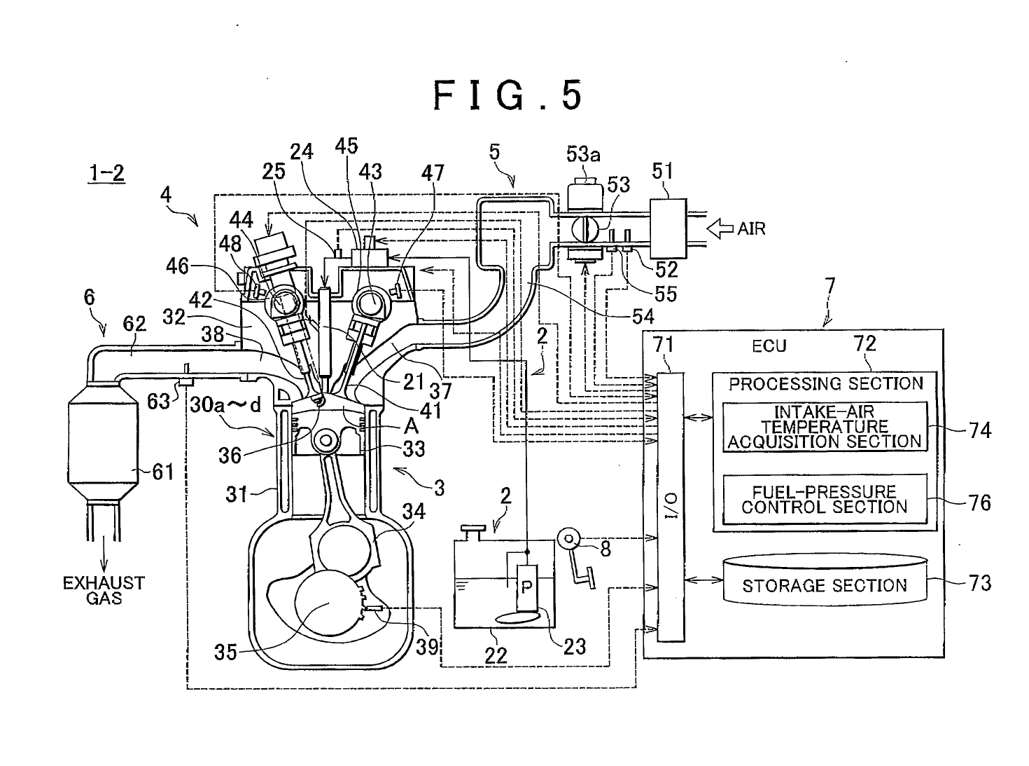

A direct-injection internal combustion engine 1-2 of a second embodiment is a spray-guided direct-injection internal combustion engine as in the case of the direct-injection internal combustion engine 1-1 of the first embodiment. FIG. 5 shows a configuration example of the spray-guided direct-injection internal combustion engine of the second embodiment. The direct-injection internal combustion engine 1-2 shown in FIG. 5 differs from the direct-injection internal combustion engine 1-1 shown in FIG. 1 in that, when the acquired intake-air temperature T is low, the fuel pressure P of the fuel to be injected into the combustion chambers A via the fuel injection valves 21 is increased. Among basic elements of the direct-injection internal combustion engine 1-2 of the second embodiment, the same elements as those of the basic elements of the direct-injection internal combustion engine 1-1 of the first embodiment (the elements indicated by the same reference numerals in FIGS. 1 and 5) will be briefly described, or description thereof will be omitted.

As a method of accelerating the vaporization of the fuel, in addition to the above-described method in which the in-cylinder temperature is increased, there is a method in which the atomization of the fuel injected via the fuel injection valves 21 is promoted. In the second embodiment, in order to promote the atomization of the fuel, the fuel pressure P of the fuel injected via the fuel injection valves 21 is increased. The high-pressure fuel pump 24 increases the fuel pressure P of the fuel, which is effected by regulating the fuel inflow via the solenoid spill valve (not shown) in the high-pressure fuel pump 24 as described above.

The fuel supply equipment 2 is provided with a fuel pressure sensor 25. The fuel pressure sensor 25, which is attached between the high-pressure fuel pump 24 and the fuel injection valves 21 in the second embodiment, detects the fuel pressure of the fuel to be injected via the fuel injection valves 21, and outputs the pressure to the ECU 7.

The processing section 72 of the ECU 7 has a fuel-pressure control section 76, which performs control of the fuel inflow via the solenoid spill valve (not shown) of the high-pressure fuel pump 24, that is, control of the fuel pressure P. In the storage section 73 of the ECU 7, instead of the variable-intake-valve closing timing map, stored is a fuel pressure map that is made based on the fuel pressure P of the fuel to be injected via the fuel injection valves 21, and the intake-air temperature T.

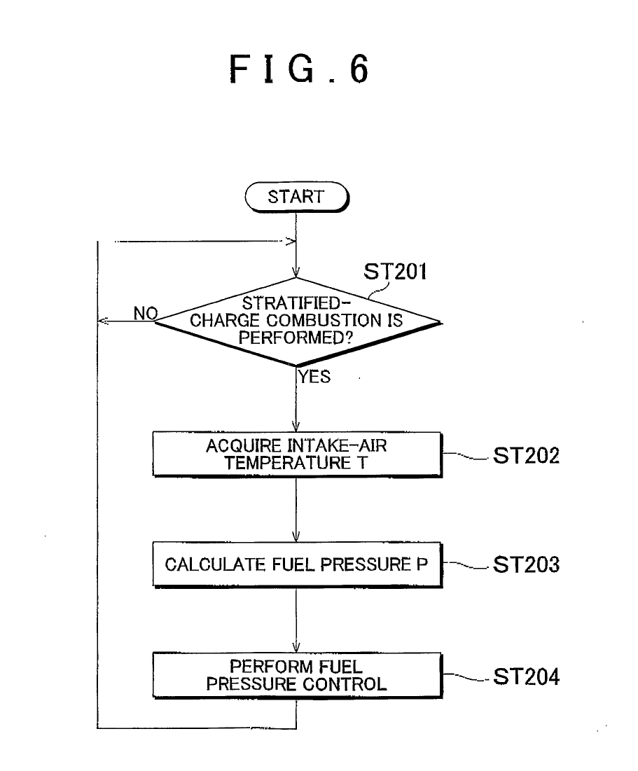

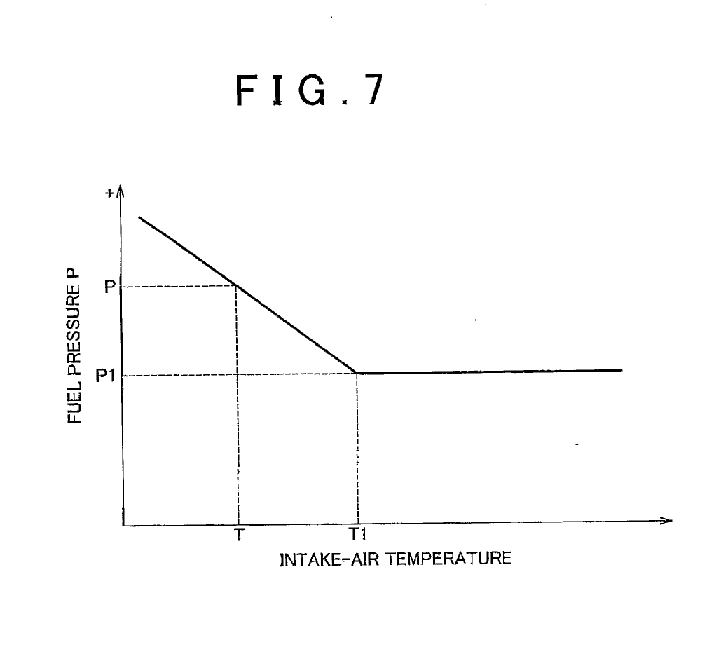

Next, an operation of the direct-injection internal combustion engine 1-2 of the second embodiment, in particular, control of the fuel pressure P of the fuel to be injected via the fuel injection valves 21, which is performed during the stratified-charge combustion, will be described. FIG. 6 shows the operational flow of the direct-injection internal combustion engine of the second embodiment. FIG. 7 shows a fuel pressure map. Brief description will be given of the part of the fuel pressure control that is shown in FIG. 6 and is performed when the direct-injection internal combustion engine 1-2 is operating in a state where the stratified-charge combustion is occurring, which part is the same as the corresponding part of the variable-intake-valve control that is shown in FIG. 3 and is performed when the direct-injection internal combustion engine 1-1 is operating in a state where the stratified-charge combustion is occurring.

First, as shown in FIG. 6, the processing section 72 of the ECU 7 determines whether the direct-injection internal combustion engine 1-2 is operating in a state where the stratified-charge combustion is occurring (ST201). If the processing section 72 determines that the direct-injection internal combustion engine 1-2 is operating in a state where the stratified-charge combustion is occurring, the intake-air temperature acquisition section 74 acquires the intake-air temperature T detected by the intake-air temperature sensor 55 (ST202).

Subsequently, the fuel-pressure control section 76 of the processing section 72 calculates the fuel pressure P from the acquired intake-air temperature T and the fuel pressure map that is made based on the intake-air temperature T and the fuel pressure P of the fuel to be injected via the fuel injection valves 21, which is stored in the storage section 73, and is shown in FIG. 5. As shown in FIG. 7, the fuel pressure map is set so that, when the intake-air temperature T is lower than the predetermined intake-air temperature T1, the fuel pressure P increases above a desired fuel pressure P1, which is the fuel pressure that depends on the state in which the direct-injection internal combustion engine 1-1 is operating. In particular, the fuel pressure map is set so that, when the intake-air temperature T is lower than the predetermined intake-air temperature T1 the amount of increase in the fuel pressure P increases in proportion to the decrease in the intake-air temperature T. Accordingly, when the acquired intake-air temperature T is lower than the predetermined intake-air temperature T1, the calculated fuel pressure P is higher than the desired fuel pressure P1. As in the case of the first embodiment, the predetermined intake-air temperature T1 means a temperature such that the intake-air temperature T lower than the predetermined intake-air temperature T1 may badly affect the combustion.

The fuel-pressure control section 76 of the processing section 72 performs fuel pressure control that is control of the fuel inflow, that is, control of the fuel pressure P, via the solenoid spill valve (not shown) of the high-pressure fuel pump 24, based on the calculated fuel pressure P (ST204). For example, the fuel-pressure control section 76 increases the fuel inflow into the high-pressure fuel pump 24 through the above-described solenoid spill valve (not shown), based on the amount of increase that is the difference between the calculated fuel pressure P and the desired fuel pressure P1. Specifically, when the direct-injection internal combustion engine 1-2 is operating in a state where the stratified-charge combustion is occurring, that is, when the fuel is injected via the fuel injection valve 21 during at least one or the compression stroke and the expansion stroke, the fuel pressure P of the fuel to be injected into the combustion chamber A via the fuel injection valve 21 is increased. The fuel-pressure control section 76 may determine, from the fuel pressure detected by the fuel pressure sensor 25, whether the actual fuel pressure is equal to the calculated fuel pressure P, and may perform feedback control so that the actual fuel pressure becomes equal to the calculated fuel pressure P. When it is determined that the acquired intake-air temperature T is equal to or higher than the predetermined intake-air temperature T1, the fuel-pressure control section 76 performs the fuel pressure control so that the fuel pressure P becomes equal to the desired fuel pressure P1.

The increase in the fuel pressure P of the fuel to be injected via the fuel injection valves 21 promotes the atomization of the fuel injected into the combustion chambers A. In particular, in the second embodiment, the fuel-pressure control section 76 promotes the atomization of the fuel by increasing the amount of increase in the fuel pressure P in proportion to the decrease in the intake-air temperature T, which is the acquired representative value representing the in-cylinder temperature. Accordingly, during the stratified-charge combustion, even if the fuel in the combustion chambers A is difficult to vaporize, the vaporization of the fuel is accelerated by promoting the atomization of the fuel, In this way, the degradation of combustion is inhibited.

In the above-described first and second embodiments, the advance amount of the closing timing of the variable intake valves 41, and the increase in the fuel pressure P of the fuel are controlled according to the decrease in the intake-air temperature T. However; the variable-intake-valve control and the fuel pressure control may be performed so that the advance amount of the closing timing of the variable intake valves 41 or the fuel pressure P of the fuel is increased by a certain amount when it is determined that the intake-air temperature T is lower than the predetermined intake-air temperature T1.

In the first and second embodiments, a map that is made based not on the intake-air temperature T but on the in-cylinder temperature may be used as the variable-intake-valve closing timing map or the fuel pressure map. In this case, the variable-intake-valve closing timing section 75 and the fuel-pressure control section 76 may calculate the advance amount or the closing timing of the variable intake valves 41 or the amount of increase in the fuel pressure from the in-cylinder temperature calculated from the detected intake-air temperature, and the map representing the relation between the in-cylinder temperature and the closing timing of the variable intake valves 41, or the fuel pressure.

In the first and second embodiments, the detected intake-air temperature T is acquired. However, instead of the intake-air temperature, the temperature of the coolant circulating in the direct-injection internal combustion engine 1-1 or 1-2 may be acquired, for example. The change in the temperature of the coolant corresponds to the change in the amount of heat in the heat sources, such as the cylinder block 31 and the pistons 33. Accordingly, the intake air introduced into the combustion chambers A is heated by the heat sources, which increases the in-cylinder temperature. In this way, the coolant temperature has an indirect influence on the in-cylinder temperature. Specifically, the in-cylinder temperature changes in response to changes in the coolant temperature. Thus, it is possible to accurately acquire the change in the in-cylinder temperature, without any temperature sensors in the combustion chambers A. The intake-air temperature acquisition section 74 may acquire the intake-air temperature and the coolant temperature, and perform the variable-intake-valve control or the fuel pressure control based on the acquired temperatures.

In the first and second embodiments, the advance amount of the closing timing of the variable intake valves 41, and the amount of increase in the fuel pressure P of the fuel are controlled according to the decrease in the intake-air temperature T. However, the control may be performed according to the decrease in the intake-air temperature T and the fuel temperature. The change in the fuel temperature has an influence on the vaporization of the fuel injected via the fuel injection valves 21. The lower the fuel temperature is, the more difficult it becomes to vaporize the fuel. For this reason, the variable-intake-valve control section 75 and the fuel-pressure control section 76 may increase the advance amount of the closing timing of the variable intake valves 41 or the amount of increase in the fuel pressure P of the fuel in proportion to the decrease in the detected fuel temperature.

In the first and second embodiments, control is performed so that, when the intake-air temperature T is low, the closing timing of the variable intake valves 41 is advanced, or the fuel pressure P of the fuel is increased. However, the closing timing of the variable intake valves 41 may be advanced and the fuel pressure P of the fuel may be increased, according to the in-cylinder temperature T, for example.

1-18. (canceled)

19. A direct-injection internal combustion engine, in which fuel injected into a combustion chamber via a fuel injection valve during a compression stroke or an expansion stroke is mixed with intake air introduced into the combustion chamber through an air intake path to form an air-fuel mixture near an ignition plug, comprising:
an actual-compression-ratio control device that controls actual compression ratio; and
a representative-value acquisition device that acquires a value representing an in-cylinder temperature,
wherein, when the fuel is injected into the combustion chamber via the fuel injection valve during the compression stroke or the expansion stroke, if the acquired representative value is low, the actual-compression-ratio control device increases the actual compression ratio.

20. The direct-injection internal combustion engine according to claim 19, wherein:
a variable intake valve, of which valve timing can be varied, is used as an air intake valve through which the air intake path and the combustion chamber communicate with each other;
the actual-compression-ratio control device is a variable-intake-valve control device that controls the valve timing of the variable intake valve; and
the variable-intake-valve control device advances a closing timing of the variable intake valve when the fuel is injected into the combustion chamber via the fuel injection valve during the compression stroke or the expansion stroke.

21. The direct-injection internal combustion engine according to claim 20, wherein the variable-intake-valve control device increases an advance amount of the closing timing of the variable intake valve in proportion to a decrease in the acquired representative value.

22. The direct-injection internal combustion engine according to claim 20, wherein the variable-intake-valve control device increases an advance amount of the closing timing of the variable intake valve by a predetermined amount when the acquired representative value is lower than a predetermined value.

23. The direct-injection internal combustion engine according to claim 19, wherein the representative-value acquisition device acquires at least one of the in-cylinder temperature, an intake-air temperature, a coolant temperature, and a fuel temperature.

24. The direct-injection internal combustion engine according to claim 19, further comprising:
at least one of an intake-air temperature detecting device that detects a temperature of the intake air introduced into the combustion chamber through the air intake path, and a coolant temperature detecting device that detects a temperature of coolant that circulates in the direct-injection internal combustion engine,
wherein the representative value to be acquired by the representative-value acquisition device is at least one of the detected intake-air temperature and the detected coolant temperature.

25. A direct-injection internal combustion engine, in which fuel injected into a combustion chamber via a fuel injection valve during a compression stroke or an expansion stroke is mixed with intake air introduced into the combustion chamber through an air intake path to form an air-fuel mixture near an ignition plug, comprising:
a fuel-pressure control device that controls pressure of the fuel to be injected into the combustion chamber via the fuel injection valve; and
a representative-value acquisition device that acquires a value representing an in-cylinder temperature,
wherein, when the fuel is injected into the combustion chamber via the fuel injection valve during the compression stroke or the expansion stroke, if the acquired representative value is low, the fuel-pressure control device increases the fuel pressure.

26. The direct-injection internal combustion engine according to claim 25, wherein the fuel-pressure control device increases an amount of increase in the fuel pressure in proportion to a decrease in the acquired representative value.

27. The direct-injection internal combustion engine according to claim 25, wherein the fuel-pressure control device increases an amount of increase in the fuel pressure by a predetermined amount when the acquired representative value is lower than a predetermined value.

28. The direct-injection internal combustion engine according to claim 25, wherein the representative-value acquisition device acquires at least one of the in-cylinder temperature, an intake-air temperature, a coolant temperature, and a fuel temperature.

29. The direct-injection internal combustion engine according to claim 25, further comprising:
at least one of an intake-air temperature detecting device that detects a temperature of the intake air introduced into the combustion chamber through the air intake path, and a coolant temperature detecting device that detects a temperature of coolant that circulates in the direct-injection internal combustion engine,
wherein the representative value to be acquired by the representative-value acquisition device is at least one of the detected intake-air temperature and the detected coolant temperature.

30. A method of controlling a direct-injection internal combustion engine, in which fuel injected into a combustion chamber via a fuel injection valve during a compression stroke or an expansion stroke is mixed with intake air introduced into the combustion chamber to form an air-fuel mixture near an ignition plug, the method comprising:
acquiring a value representing an in-cylinder temperature; and
when the fuel is injected into the combustion chamber via the fuel injection valve during the compression stroke or the expansion stroke, if the acquired representative value is low, increasing actual compression ratio.

31. The method of controlling a direct-injection internal combustion engine according to claim 30, wherein:
the direct-injection internal combustion engine includes a variable intake valve of which valve timing can be varied, and through which the air intake path and the combustion chamber communicate with each other; and
when the fuel is injected into the combustion chamber via the fuel injection valve during the compression stroke or the expansion stroke, if the acquired representative value is low, the closing timing of the variable intake valve is advanced.

32. The method of controlling a direct-injection internal combustion engine according to claim 30, wherein an advance amount of a closing timing of the variable intake valve is increased in proportion to a decrease in the acquired representative value.

33. The method of controlling a direct-injection internal combustion engine according to claim 30, wherein an advance amount of a closing timing of the variable intake valve is increased by a predetermined amount when the acquired representative value is lower than a predetermined value.

34. The method of controlling a direct-injection internal combustion engine according to claim 30, wherein at least one of the in-cylinder temperature, an intake-air temperature, a coolant temperature, and a fuel temperature is acquired as the value representing the in-cylinder temperature.

35. The method of controlling a direct-injection internal combustion engine according to claim 30, wherein:
the direct-injection internal combustion engine includes at least one of an intake-air temperature detecting device that detects a temperature of the intake air introduced into the combustion chamber through the air intake path, and a coolant temperature detecting device that detects a temperature of coolant that circulates in the direct-injection internal combustion engine; and
at least one of the intake-air temperature and the coolant temperature is acquired as the value representing the in-cylinder temperature.

36. A method of controlling a direct-injection internal combustion engine, in which fuel injected into a combustion chamber via a fuel injection valve during a compression stroke or an expansion stroke is mixed with intake air introduced into the combustion chamber to form an air-fuel mixture near an ignition plug, the method comprising:
acquiring a value representing an in-cylinder temperature; and
when the fuel is injected into the combustion chamber via the fuel injection valve during the compression stroke or the expansion stroke, if the acquired representative value is low, increasing fuel pressure.

37. The method of controlling a direct-injection internal combustion engine according to claim 36, wherein an amount of increase in the fuel pressure is increased in proportion to a decrease in the acquired representative value.

38. The method of controlling a direct-injection internal combustion engine according to claim 36, wherein an amount of increase in the fuel pressure is increased by a predetermined amount when the acquired representative value is lower than a predetermined value.

39. The method of controlling a direct-injection internal combustion engine according to claim 36, wherein at least one of the in-cylinder temperature, an intake-air temperature, a coolant temperature, and a fuel temperature is acquired as the value representing the in-cylinder temperature.

40. The method of controlling a direct-injection internal combustion engine according to claim 36, wherein:
the direct-injection internal combustion engine includes at least one of an intake-air temperature detecting device that detects a temperature of the intake air introduced into the combustion chamber through the air intake path, and a coolant temperature detecting device that detects a temperature of coolant that circulates in the direct-injection internal combustion engine; and
at least one of the intake-air temperature and the coolant temperature is acquired as the value representing the in-cylinder temperature.
